(19) United States
(12) Patent Application Publication
(10) Pub. No.: US 2025/0381673 A1
(43) Pub. Date: Dec. 18, 2025

(54) SYSTEM AND PROGRAM

(71) Applicant: Sony Semiconductor Solutions Corporation, Kanagawa (JP)

(72) Inventor: Tsubasa KUROKAWA, Kanagawa (JP)

(73) Assignee: Sony Semiconductor Solutions Corporation, Kanagawa (JP)

(21) Appl. No.: 18/878,095

(22) PCT Filed: Jun. 20, 2023
(86) PCT No.: PCT/JP2023/022681

§ 371 Date: Dec. 23, 2024

(30) Foreign Application Priority Data
Jul. 1, 2022 (JP) 2022-106770

(51) Int. Cl. B25J 9/16; B25J 13/08; B25J 19/02

(52) U.S. Cl. CPC B25J 9/1676; B25J 9/1697; B25J 13/089; B25J 19/021

(57) ABSTRACT

To improve detection accuracy of an object interfering with a work device. A system includes an interference region detection unit, an interference region image generation unit, and an interference object detection unit. The interference region detection unit detects an interference region that is a region where, in a main body device including a work device including a movable unit, the work device interferes with an object. The interference region image generation unit generates, from a distance image that is an image in which distance information is reflected for each pixel, based on the interference region, an interference region image that is a region of the distance image including an interference object that is an object interfering with the work device. The interference object detection unit detects an interference object based on the interference region image.

### FIELD

The present disclosure relates to a system and a program.

### BACKGROUND

There has been proposed a device that detects, in a work device including a movable unit such as an industrial robot arm, an object interfering with the work device and prevents collision with the object. For example, there has been proposed a manipulator that is a robot arm, the manipulator detecting an obstacle intruding into an operation space (see, for example, Patent Literature 1). The manipulator includes a link, a joint that turns the link, and a distance sensor installed with a sensing direction directed in a direction parallel to the surface of the link. The distance sensor monitors an obstacle intruding into a local monitoring space installed in the turning direction of the link.

### CITATION LIST

### Patent Literature

Patent Literature 1: JP 2019-202405 A

### SUMMARY

### Technical Problem

However, in the related art explained above, since a background is greatly changed by a motion such as the turning of the manipulator, there is a problem in that the accuracy of detecting an object by the distance sensor is deteriorated.

Therefore, the present disclosure proposes a system that improves detection accuracy of an object that interferes with a work device.

### Solution to Problem

A system according to the present disclosure includes an interference region detection unit, an interference region image generation unit, and an interference object detection unit. The interference region detection unit detects an interference region that is a region where, in a main body device including a work device including a movable unit, the work device interferes with an object. The interference region image generation unit generates, from a distance image that is an image in which distance information is reflected for each pixel, based on the interference region, an interference region image that is a region of the distance image including an interference object that is an object interfering with the work device. The interference object detection unit detects the interference object based on the interference region image.

Furthermore, a program according to the present disclosure includes: a procedure of detecting an interference region that is a region where, in a main body device including a work device including a movable unit, the work device interferes with an object; and a procedure of generating, from a distance image that is an image in which distance information is reflected for each pixel, based on the interference region, an interference region image that is a region of the distance image including an interference object that is an object interfering with the work device; and a procedure of detecting the interference object based on the interference region image.

### BRIEF DESCRIPTION OF DRAWINGS

FIG. 1 is a diagram illustrating a configuration example of a robot arm according to an embodiment of the present disclosure.

FIG. 2 is a diagram illustrating a configuration example of an object detection system according to a first embodiment of the present disclosure.

FIG. 3A is a diagram illustrating an example of an interference region according to the first embodiment of the present disclosure.

FIG. 3B is a diagram illustrating an example of an interference region according to the first embodiment of the present disclosure.

FIG. 4A is a view illustrating an example of a distance image according to the first embodiment of the present disclosure.

FIG. 4B is a diagram illustrating an example of an interference region image according to the first embodiment of the present disclosure.

FIG. 5 is a diagram illustrating an example of object detection processing according to the first embodiment of the present disclosure.

FIG. 6 is a diagram illustrating a configuration example of an object detection system according to a second embodiment of the present disclosure.

FIG. 7 is a diagram illustrating a configuration example of an object detection system according to a third embodiment of the present disclosure.

FIG. 8 is a diagram illustrating an example of an interference region according to the third embodiment of the present disclosure.

FIG. 9 is a diagram illustrating a configuration example of an object detection system according to a fourth embodiment of the present disclosure.

FIG. 10 is a diagram illustrating an example of an interference region according to the fourth embodiment of the present disclosure.

### DESCRIPTION OF EMBODIMENTS

Embodiments of the present disclosure are explained in detail below with reference to the drawings. Explanation is made in the following order. Note that, in the embodiments explained below, redundant explanation is omitted by denoting the same parts with the same reference numerals and signs.
1. First Embodiment
2. Second Embodiment
3. Third Embodiment
4. Fourth Embodiment

### 1. First Embodiment

### [Configuration of a Work Device]

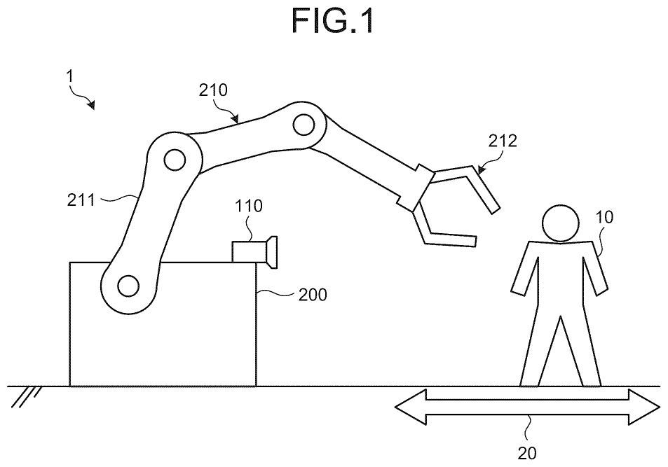

FIG. 1 is a diagram illustrating a configuration example of a robot arm according to an embodiment of the present disclosure. The figure is a diagram for explaining a robot arm 1 to which a monitoring system of the present disclosure can be applied. The robot arm 1 is a device that performs work such as grasping and carrying a target object on behalf of a human arm. The robot arm 1 illustrated in the figure includes a main body device 200 and a work device 210.

The work device 210 includes a plurality of links 211 respectively turnably attached and a hand 212. The links 211 are portions corresponding to bones of an arm of the robot arm 1. The hand 212 grips a conveyance target object.

The main body device 200 is a device that holds the work device 210 and drives the work device 210.

Based on the control of the main body device 200, the work device 210 can extend and contract and turn to carry the held conveyance target object to any position within a movable range. The main body device 200 can drive the work device 210 with remote control or automatic control by an operator.

When an object other than the conveyance target object is present in the vicinity of the movable range of the work device 210, it is likely that the object comes into contact or collides with the work device 210. By detecting such an object that interferes with the work device 210, it is possible to ensure safety of work. An interference object 10 is illustrated in the figure. The interference object 10 is a person who approaches the work device 210. An object detection system (an object detection system 100) of the present disclosure is a system that detects a person as the interference object 10 when the person intrudes into a movable range 20 of the work device 210. By detecting the interference object 10, processing such as issuing a warning can be performed. A distance measuring sensor 110, which is a sensor for detecting the interference object 10, is disposed in the main body device 200 illustrated in the figure. Details of the distance measuring sensor 110 are explained below.

### [Configuration of the Object Detection System]

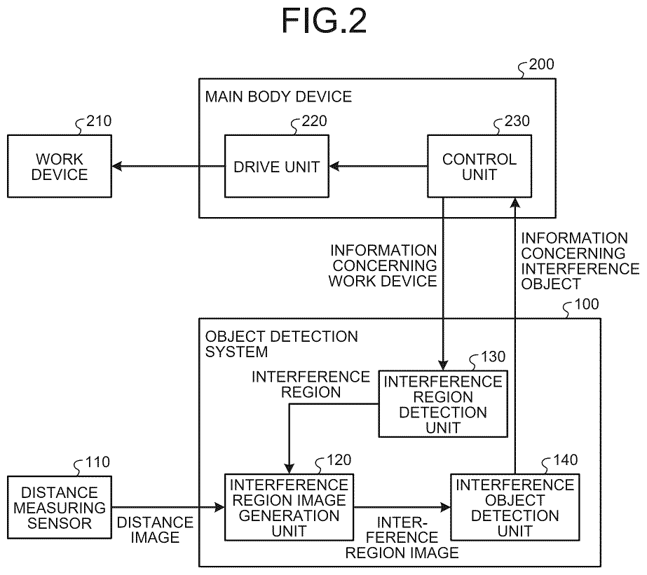

FIG. 2 is a diagram illustrating a configuration example of the object detection system according to a first embodiment of the present disclosure. The figure is a block diagram illustrating a configuration example of the object detection system 100.

Note that the work device 210 and the main body device 200 are further illustrated in the figure. The main body device 200 includes a drive unit 220 and a control unit 230. The drive unit 220 drives the work device 210. The control unit 230 controls the drive unit 220. The control unit 230 controls the drive unit 220 based on operation of an operator or the like and causes the work device 210 to, for example, expand and contract and grip a conveyance target object. Note that the control unit 230 illustrated in the figure outputs information concerning the work device to an interference region detection unit 130 of the object detection system 100. For example, a movable range of the work device 210 corresponds to the information concerning the work device. In addition, an extension and contraction direction, an extension length, and moving speed of the work device 210 can also be applied as the information concerning the work device.

The distance measuring sensor 110 is further illustrated in the figure. As illustrated in FIG. 1, the distance measuring sensor 110 is a sensor that is disposed in the main body device 200 or the like and measures the distance to an object disposed in the vicinity of the work device 210. The distance to the object can be measured by, for example, a time of flight (ToF) method. The ToF method is a distance measuring method for measuring the distance to an object by irradiating the object with light and measuring a time for the light to travel between the distance measuring sensor 110 and the object. The distance measuring sensor 110 illustrated in the figure generates a distance image based on data of the distance to the detected object. Here, the distance image is an image in which distance information is reflected for each pixel. The distance measuring sensor 110 outputs the generated distance image to an interference region image generation unit 120 explained below.

The object detection system 100 includes the interference region image generation unit 120, the interference region detection unit 130, and an interference object detection unit 140.

The interference region detection unit 130 detects an interference region. This interference region is a region where the work device 210 interferes with an object. The interference object 10 such as a person present in the interference region is likely to come into contact with the work device 210. The interference region can be detected based on, for example, a movable range of the work device 210. Specifically, a range obtained by adding an offset to the movable range of the work device 210 can be detected as the interference region. The movable range of the work device 210 can be acquired from information of the work device output from the control unit 230 of the main body device 200. In addition, it is also possible to detect an interference region where the movable range is further limited by information such as an extension and contraction direction, an extension length, and moving speed of the work device 210. The interference region detection unit 130 outputs the detected interference region to the interference region image generation unit 120.

The interference region image generation unit 120 generates an interference region image from the distance image output from the distance measuring sensor 110. The interference region image is a region of a distance image including the interference object. The interference region image generation unit 120 generates the interference region image based on the interference region. Specifically, the interference region image generation unit 120 can generate the interference region image by extracting a region included in the interference region from the distance image.

The interference region image generation unit 120 can also generate the interference region image by performing processing of excluding an object not included in the interference region from the distance image. For example, a background image of a relatively distant building or the like corresponds to the object not included in the interference region. By excluding such a background image and determining whether the remaining object is included in the interference region, it is possible to improve the accuracy of the interference region image. It is also possible to improve processing speed of generating the interference region image.

The interference region image generation unit 120 outputs the generated interference region image to the interference object detection unit 140.

The interference object detection unit 140 detects an interference object based on the interference region image output from the interference region image generation unit 120. For example, the interference object detection unit 140 can extract an object from the interference region image, determine whether the extracted object is an interference object, and detect the interference object. The determination as to whether the object is an interference object can be performed by artificial intelligence (AI) processing.

The interference object detection unit 140 can output information concerning the detected interference object to the control unit 230. Based on the output information concerning the interference object, the control unit 230 can perform processing of stopping the operation of the work device 210 or issuing a warning.

### [Interference Region]

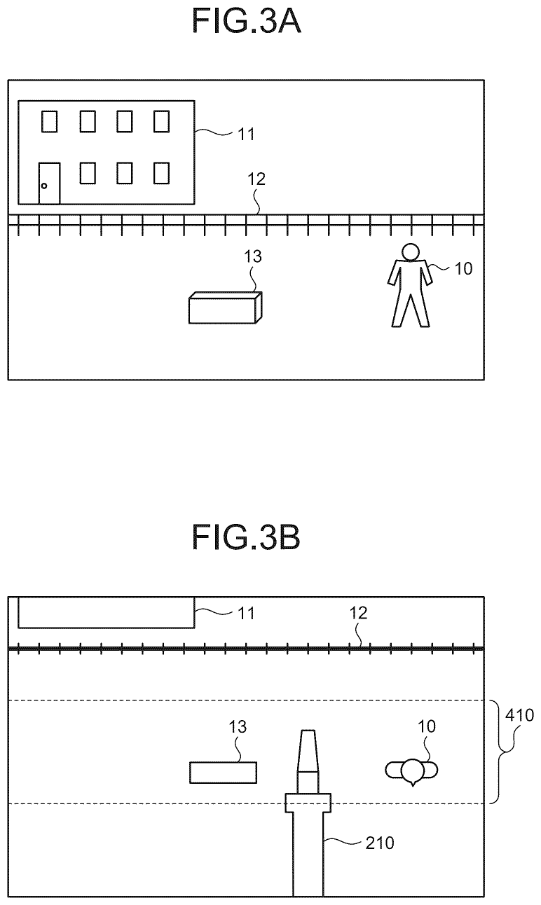

FIGS. 3A and 3B are diagrams illustrating an example of an interference region according to the first embodiment of the present disclosure. FIG. 3A is a diagram illustrating an example of an image of a sensing range in the distance measuring sensor 110. In the figure, a building 11 and a fence 12 corresponding to a background image are illustrated besides a conveyance target object 13 and the interference object 10.

FIG. 3B is obtained by converting the image illustrated in FIG. 3A into a bird's-eye view image. The work device 210 and an interference region 410 are further illustrated in the figure. A region sandwiched by dotted lines in the figure represents the interference region 410. Among objects included in the interference region 410, the interference object detection unit 140 excludes the conveyance target object 13 handled by the work device 210 including the interference object detection unit 140 from the interference object and detects a person as the interference object 10. The conveyance target object 13 can be recognized as a known object by AI.

### [Distance Image]

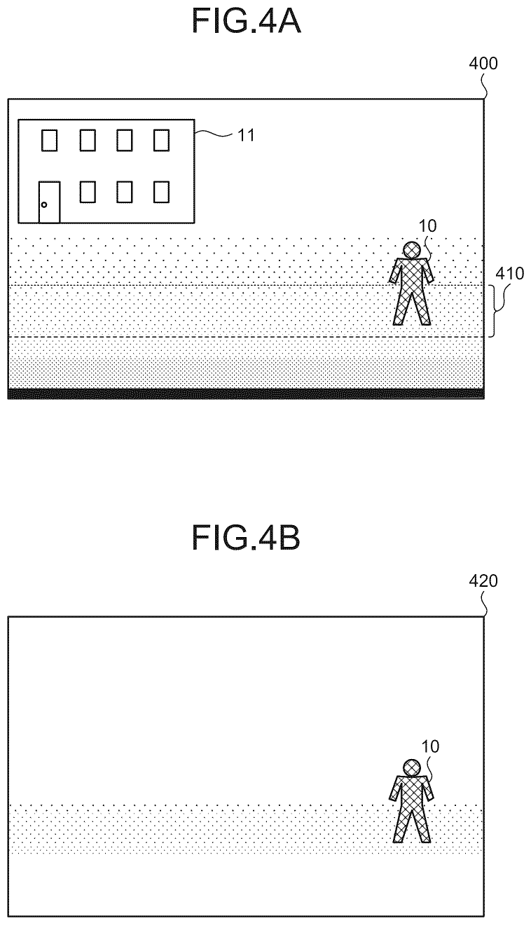

FIG. 4A is a diagram illustrating an example of a distance image according to the first embodiment of the present disclosure. The figure is a diagram illustrating a distance image 400 corresponding to the image illustrated in FIG. 3A. The distance image 400 in the figure is an image in which distance information is represented by shading. Dark regions represent short distance objects and thin regions represent long distance objects. The building 11, which is the background image, is a white image. By using such a distance image, objects included in the interference region 410 can be easily detected. Note that an image in which distance information is represented by a color can also be used as the distance image.

### [Interference Region Image]

FIG. 4B is a diagram illustrating an example of an interference region image according to the first embodiment of the present disclosure. The figure is a diagram illustrating an interference region image 420 corresponding to the image illustrated in FIG. 3A. The interference region image 420 illustrated in the figure is equivalent to an image obtained by extracting a region included in the interference region 410 from the distance image 400.

### [Object Detection Processing]

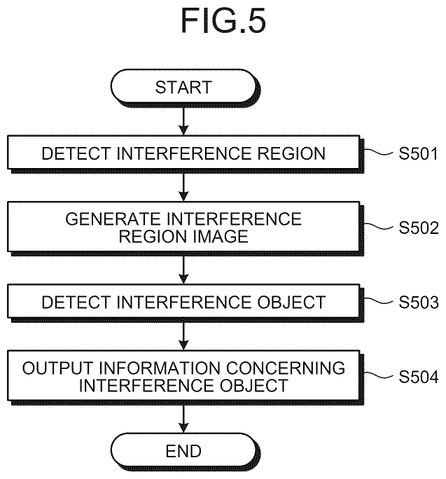

FIG. 5 is a diagram illustrating an example of object detection processing according to the first embodiment of the present disclosure. The figure is a flowchart illustrating an example of a processing procedure of interference object detection processing in the object detection system 100. First, the interference region detection unit 130 detects an interference region based on information concerning the work device (Step S501). Subsequently, the interference region image generation unit 120 generates an interference region image based on a distance image and the interference region (Step S502). Subsequently, the interference object detection unit 140 detects an interference object based on the interference region image (Step S503). Subsequently, the interference object detection unit 140 generates information concerning the interference object and outputs the information to the control unit 230 (Step S504). By the processing explained above, the interference object can be detected.

As explained above, the object detection system 100 in the first embodiment of the present disclosure extracts an object included in the detected interference region from the distance image and determines whether the extracted object is an interference object. At this time, since the background image and the like can be excluded, the detection accuracy of the interference object can be improved.

### 2. Second Embodiment

The object detection system 100 in the first embodiment explained above detects the interference object from the interference region image. In contrast, the object detection system 100 in a second embodiment of the present disclosure is different from the object detection system 100 in the first embodiment in that an interference object is detected based on an interference region image and an image.

### [Configuration of the Object Detection System]

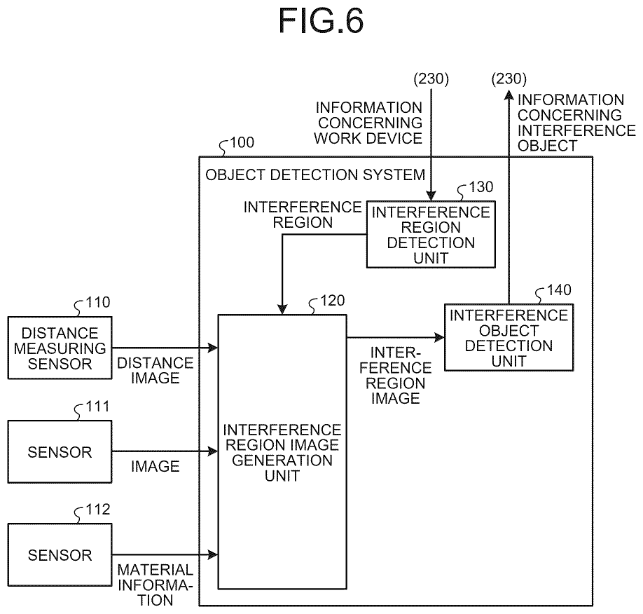

FIG. 6 is a diagram illustrating a configuration example of the object detection system according to the second embodiment of the present disclosure. The figure is a block diagram illustrating a configuration example of the object detection system 100 like FIG. 2. The object detection system 100 is different from the object detection system 100 illustrated in FIG. 2 in that the interference region image generation unit 120 processes data from a plurality of sensors.

A sensor 111 illustrated in the figure is a sensor that generates an image including an object such as the interference object 10. For example, a stereo camera can be applied to the sensor 111. The sensor 111 outputs the generated image to the interference region image generation unit 120.

A sensor 112 illustrated in the figure is a sensor that discriminates a material of an object. The sensor 112 outputs information concerning the material to the interference region image generation unit 120.

As explained above, the distance measuring sensor 110 measures the distance to the object based on reflected light of irradiated light. However, depending on a material of an object, an error in distance measurement increases. For example, the error increases in an object having a high light reflectance such as metal. In such a case, the interference object 10 can be detected by using a normal image instead of the distance image. The interference region image generation unit 120 illustrated in the figure selects either the distance image from the distance measuring sensor 110 or the image from the sensor 112 based on the material information from the sensor 111. Subsequently, the interference region image generation unit 120 extracts a region included in the interference region for the selected distance image and image and outputs the region as an interference region image.

Components of the object detection system 100 other than the above are the same as the components of the object detection system 100 in the first embodiment of the present disclosure. Therefore, explanation of the components is omitted.

As explained above, the object detection system 100 in the second embodiment of the present disclosure selects the distance image and the image according to the material of the object and detects the interference object 10. Accordingly, it is possible to further improve the detection accuracy of the interference object 10.

### 3. Third Embodiment

The object detection system 100 according to the first embodiment explained above generates the interference region image based on the interference region of the work device. In contrast, the object detection system 100 in a third embodiment of the present disclosure is different from the object detection system 100 in the first embodiment in that position information of an object is further used.

### [Configuration of the Object Detection System]

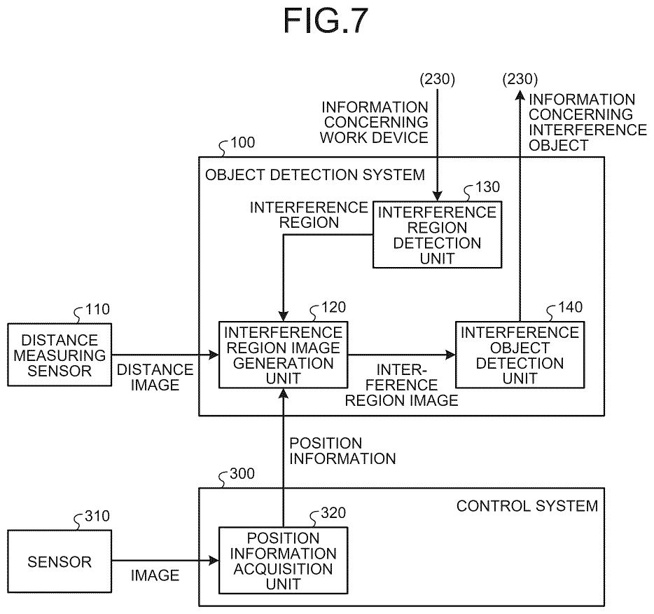

FIG. 7 is a diagram illustrating a configuration example of the object detection system according to the third embodiment of the present disclosure. The figure is a block diagram illustrating a configuration example of the object detection system 100 like FIG. 2. The object detection system 100 is different from the object detection system 100 illustrated in FIG. 2 in that position information from a control system 300 is input to the interference region image generation unit 120.

A sensor 310 illustrated in the figure is a sensor that generates and outputs an image of the vicinity of the work device 210. The control system 300 illustrated in the figure detects the position of an object serving as a background based on an image from the sensor 310. A position information acquisition unit 320 generates position information based on the detected position of the background and outputs the position information to the interference region image generation unit 120. The sensor 310 and the control system 300 are assumed to be a fixed-point camera device or a drone device. Note that the control system 300 is an example of another system described in the claims.

The interference region image generation unit 120 illustrated in the figure generates an interference region image based on the distance image, the interference region, and the position information.

### [Interference Region]

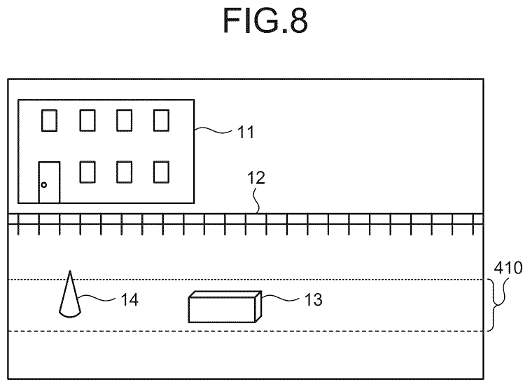

FIG. 8 is a diagram illustrating an example of an interference region according to the third embodiment of the present disclosure. The figure is a diagram illustrating an example of an image of a sensing range in the distance measuring sensor 110 like FIG. 3A. In the figure, a known object 14 is described besides the conveyance target object 13. The object 14 is an image equivalent to a background image. The object 14 may be, for example, an object that causes no problem even if the object collides with the work device 210 such as a pylon. The sensor 310 and the control system 300 illustrated in FIG. 7 generate an image of the vicinity of the work device 210, detect a known object such as the object 14, generate position information, and output the position information to the interference region image generation unit 120. The interference region image generation unit 120 excludes the object 14 as the background image based on the position information and determines whether the remaining object is included in the interference region.

Components of the object detection system 100 other than the above are the same as the components of the object detection system 100 in the first embodiment of the present disclosure. Therefore, explanation of the components is omitted.

As explained above, the object detection system 100 in the third embodiment of the present disclosure detects the interference object 10 using the position information from the other systems. Accordingly, it is possible to further improve the detection accuracy of the interference object 10.

### 4. Fourth Embodiment

The object detection system 100 according to the first embodiment explained above uses the information concerning the work device from the control unit 230 of the main body device 200 to which the object detection system 100 is connected. In contrast, the object detection system 100 in a fourth embodiment of the present disclosure is different from the object detection system 100 in the first embodiment in that information concerning a work device from the control unit 230 of another main body device 200 is further used.

### [Configuration of the Object Detection System]

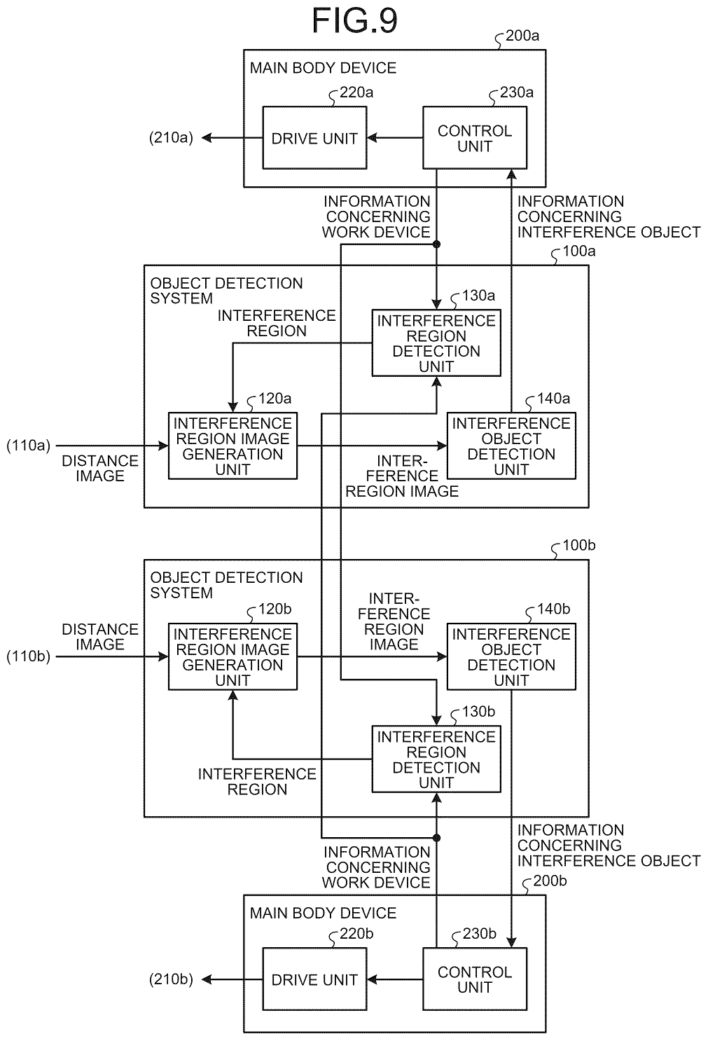

FIG. 9 is a diagram illustrating a configuration example of the object detection system according to the fourth embodiment of the present disclosure. The figure is a block diagram illustrating a configuration example of the object detection system 100 like FIG. 2. Note that the two main body devices 200 and two object detection systems 100 are illustrated in the figure The main body devices and the object detection systems 100 are identified by adding “a” and “b” to reference numerals thereof. The main body device 200a and the main body device 200b are devices that are disposed in the same workplace and individually perform work. The object detection system 100a detects the interference object 10 with the work device 210a attached to the main body device 200a. Similarly, the object detection system 100b detects the interference object 10 with the work device 210b attached to the main body device 200b.

In addition to information concerning the work device from the control unit 230 that is a target of the object detection system 100 including the interference region detection unit 130, information concerning the work device from the control unit 230 targeted by another object detection system 100 is input to the interference region detection unit 130 illustrated in the figure. The interference region detection unit 130 in the figure detects an interference region based on the information of these plurality of work devices.

### [Interference Region]

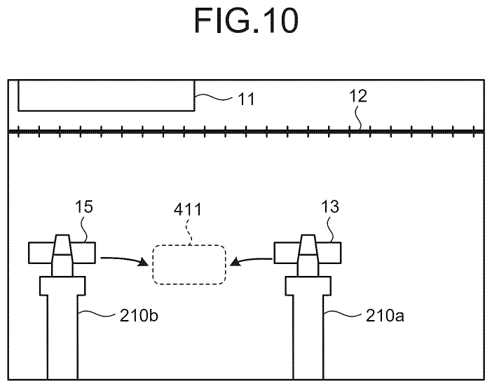

FIG. 10 is a diagram illustrating an example of an interference region according to the fourth embodiment of the present disclosure. The figure is a diagram illustrating a bird's-eye view image of the vicinity of the work device 210 like FIG. 3. The figure illustrates a state in which the work device 210a and the work device 210b individually perform work. The work device 210a illustrated in the figure grips and conveys the conveyance target object 13. The work device 210b illustrated in the figure grips and conveys a conveyance target object 15. When the work device 210a illustrated in the figure is explained as an example, the conveyance target object 13 conveyed by the work device 210a does not correspond to an interference object. On the other hand, the work device 210b and the conveyance target object 15 sometimes correspond to an interference object. For example, when the work device 210a and the work device 210b convey a conveyance target object to the same region (for example, a region 411 in the figure), a gripping unit or the like of the work device 210b correspond to the interference object for the work device 210a.

Therefore, the interference region detection unit 130a acquires the position of the work device 210b using the information concerning the work device from the control unit 230b and detects the interference region. At this time, the control unit 230b can output, to the control unit 230a, information concerning the work device including information concerning the position of the conveyance target object 15 conveyed by the control unit 230b. The work device 210a can detect the interference region based on the acquired information concerning the position of the conveyance target object 15. Note that the control unit 230b is an example of another system described in the claims.

Note that configuration of the object detection system 100 is not limited to this example. For example, a control device that simultaneously controls a plurality of main body devices 200 can be used as the control unit 230b.

Since components of the object detection system 100 other than the above are the same as the components of the object detection system 100 in the first embodiment of the present disclosure, explanation of the components is omitted.

As explained above, the object detection system 100 in the fourth embodiment of the present disclosure detects the interference region based on the information concerning the work device from the control unit 230 of the main body device 200 to which the object detection system is attached and the control unit 230 of the other main body device 200. Accordingly, it is possible to improve the detection accuracy of the interference object when the plurality of work devices 210 operate.

Note that the configuration of the second embodiment of the present disclosure can be applied to the other embodiments. Specifically, the interference region image generation unit 120 illustrated in FIG. 6 can be applied to the third and fourth embodiments of the present disclosure.

The configuration of the third embodiment of the present disclosure can be applied to the other embodiments. Specifically, the configuration of the interference region image generation unit 120 illustrated in FIG. 7 can be applied to the second and fourth embodiments of the present disclosure.

### Other Modifications

The object detection system 100 of the present embodiment may be implemented by a dedicated computer system or may be implemented by a general-purpose computer system.

For example, a program for executing the operation explained above is stored in a computer-readable recording medium such as an optical disk, a semiconductor memory, a magnetic tape, or a flexible disk and distributed. Then, for example, the control device is configured by installing the program in a computer and executing the processing explained above.

The communication program explained above may be stored in a disk device included in a server device on a network such as the Internet to make it possible to download the communication program to a computer. The functions explained above may be implemented by cooperation of an OS (Operating System) and application software. In this case, a portion other than the OS may be stored in a medium and distributed or the portion other than the OS may be stored in the server device to make it possible to download the portion to the computer.

Among the kinds of processing explained in the embodiment, all or a part of the processing explained as being automatically performed can be manually performed or all or a part of the processing explained as being manually performed can be automatically performed by a publicly-known method. Besides, the processing procedures, the specific names, and the information including the various data and parameters explained in the document and illustrated in the figures can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing processing contents to contradict one another. The order of the steps illustrated the flowchart in the embodiment explained above can be changed as appropriate.

For example, the present embodiments can be implemented as any component configuring a device or a system, for example, a processor functioning as a system LSI (Large Scale Integration) or the like, a module that uses a plurality of processors or the like, a unit that uses a plurality of modules or the like, or a set obtained by further adding other functions to the unit (that is, a component as a part of the device).

Note that, in the present embodiments, the system means a set of a plurality of components (devices, modules (components), and the like). It does not matter whether all the components are present in the same housing. Therefore, both of a plurality of devices housed in separate housings and connected via a network and one device in which a plurality of modules is housed in one housing are systems.

For example, the present embodiment can adopt a configuration of cloud computing in which one function is shared and processed by a plurality of devices in cooperation via a network.

Although the embodiments of the present disclosure are explained above, the technical scope of the present disclosure is not limited to the embodiments per se. Various changes can be made without departing from the gist of the present disclosure. Components in different embodiments and modifications may be combined as appropriate.

The processing procedure explained in the embodiments may be regarded as a method including these series of procedures and may be regarded as a program for causing a computer to execute these series of procedures or a recording medium storing the program. As this recording medium, for example, a flexible disk, a Compact Disc Read Only Memory (CD-ROM), a Magnet optical (MO) disk, a Digital Versatile Disc (DVD), a Blu-ray disc (registered trademark), a magnetic disk, a semiconductor memory, a memory card, and the like can be used.

Note that the effects described in this specification are only illustrations and are not limited. Other effects may be present.

Note that this technology can also take the following configurations.

(1) A system comprising:
an interference region detection unit that detects an interference region that is a region where, in a main body device including a work device including a movable unit, the work device interferes with an object; and
an interference region image generation unit that generates, from a distance image that is an image in which distance information is reflected for each pixel, based on the interference region, an interference region image that is a region of the distance image including an interference object that is an object interfering with the work device; and
an interference object detection unit that detects the interference object based on the interference region image.
   (2) The system according to the above (1), wherein the interference region detection unit detects the interference region based on information concerning the work device.
   (3) The system according to the above (2), wherein the interference region detection unit detects the interference region, using a movable range of the work device as the information concerning the work device.
   (4) The system according to the above (2), wherein the interference region detection unit detects the interference region based on the information concerning the work device output from a control unit of the work device.
   (5) The system according to the above (2), wherein the interference region detection unit detects the interference region based on information output from another system and the information concerning the work device of the system.
   (6) The system according to the above (5), wherein the interference region detection unit detects the interference region, using a position of an object near the work device as the information output from the another system.
   (7) The system according to the above (5), wherein the another system is a system that controls the work device.
   (8) The system according to any one of the above (1) to (7), wherein the interference region image generation unit generates the interference region image based on the interference region, the distance image, and an image of the object.
   (9) The system according to any one of the above (1) to (7), wherein the interference region image generation unit generates the interference region image based on the interference region, the distance image, and a material of the object.
   (10) A program comprising:
a procedure of detecting an interference region that is a region where, in a main body device including a work device including a movable unit, the work device interferes with an object; and
a procedure of generating, from a distance image that is an image in which distance information is reflected for each pixel, based on the interference region, an interference region image that is a region of the distance image including an interference object that is an object interfering with the work device; and
a procedure of detecting the interference object based on the interference region image.

### REFERENCE SIGNS LIST

1 ROBOT ARM
10 INTERFERENCE OBJECT
20 MOVABLE RANGE
100, 100a, 100b OBJECT DETECTION SYSTEM
110 DISTANCE MEASURING SENSOR
111, 112, 310 SENSOR
120 INTERFERENCE REGION IMAGE GENERATION UNIT
130, 130a, 130b INTERFERENCE REGION DETECTION UNIT
200, 200a, 200b MAIN BODY DEVICE
210, 210a, 210b WORK DEVICE
220, 220a, 220b DRIVE UNIT
230, 230a, 230b CONTROL UNIT
300 CONTROL SYSTEM
320 POSITION INFORMATION ACQUISITION UNIT
400 DISTANCE IMAGE
410 INTERFERENCE REGION
420 INTERFERENCE REGION IMAGE

1. A system comprising:
an interference region detection unit that detects an interference region that is a region where, in a main body device including a work device including a movable unit, the work device interferes with an object; and
an interference region image generation unit that generates, from a distance image that is an image in which distance information is reflected for each pixel, based on the interference region, an interference region image that is a region of the distance image including an interference object that is an object interfering with the work device; and
an interference object detection unit that detects the interference object based on the interference region image.

2. The system according to claim 1, wherein the interference region detection unit detects the interference region based on information concerning the work device.

3. The system according to claim 2, wherein the interference region detection unit detects the interference region, using a movable range of the work device as the information concerning the work device.

4. The system according to claim 2, wherein the interference region detection unit detects the interference region based on the information concerning the work device output from a control unit of the work device.

5. The system according to claim 2, wherein the interference region detection unit detects the interference region based on information output from another system and the information concerning the work device of the system.

6. The system according to claim 5, wherein the interference region detection unit detects the interference region, using a position of an object near the work device as the information output from the another system.

7. The system according to claim 5, wherein the another system is a system that controls the work device.

8. The system according to claim 1, wherein the interference region image generation unit generates the interference region image based on the interference region, the distance image, and an image of the object.

9. The system according to claim 1, wherein the interference region image generation unit generates the interference region image based on the interference region, the distance image, and a material of the object.

10. A program comprising:
a procedure of detecting an interference region that is a region where, in a main body device including a work device including a movable unit, the work device interferes with an object; and
a procedure of generating, from a distance image that is an image in which distance information is reflected for each pixel, based on the interference region, an interference region image that is a region of the distance image including an interference object that is an object interfering with the work device; and
a procedure of detecting the interference object based on the interference region image.
